(19) United States
(12) Patent Application Publication
(10) Pub. No.: US 2008/0159586 A1
(43) Pub. Date: Jul. 3, 2008

(54) Watermarking of an Image Motion Signal

(75) Inventors: Adriaan Johan Van Leest, Eindhoven (NL); Alphons Antonius Maria Lambertus Bruekers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,129

(22) PCT Filed: Apr. 13, 2006
(86) PCT No.: PCT/IB06/51151

§ 371 Date: Oct. 10, 2007

(30) Foreign Application Priority Data
Apr. 14, 2005 (EP) 05102933.8

(51) Int. Cl. G06K 9/00; G06K 9/40

(52) U.S. Cl. 382/100; 382/255

(57) ABSTRACT

The present invention relates to a method for embedding a watermark (w) in an image motion signal (55). The invention describes a method for embedding a watermark (w) in a motion image signal (55) in the optical domain in several steps. Initially, the watermark, i.e. the information for embedding, is represented by a sequence of watermark samples. During embedding sharpness changing means (10) are applied to change the sharpness in response to the watermark samples, and thereby embedding the watermark in the motion image signal (55) in a simple and efficient manner in the optical domain. The sharpness changing can be implemented by various ways, e.g. by displacing a lens (10) slightly. A particular embodiment exploits a variable focus lens having a liquid lens operated by electro-wetting. Further, the present invention relates to a corresponding apparatus for embedding the watermark.

### FIELD OF THE INVENTION

The present invention relates to a method for embedding a watermark in an image motion signal. Further, the present invention relates to a corresponding apparatus for embedding the watermark.

### BACKGROUND OF THE INVENTION

Within the commercial area of movies and related areas, there is an increasing demand for copy prevention and control. Recently, the possibilities for watermarking of audio-visual objects have been introduced to assist in copy prevention and control. A watermark may be defined as a general term that can refer to either an embedded message, a reference pattern, a message pattern, or an added pattern. A watermark in a movie or similar may contain information beneficial in that respect, such as the copyright owner, identity of the purchaser, or a tag like ‘copy never’, ‘copy-once’, etc. Preferably, recording devices should detect such tags and comply accordingly.

WO 03/001813 discloses a video watermarking method working in the digital domain intended for use in projectors in cinemas and similar places. The proposed method only exploits the temporal axis making the method very robust, i.e. geometrical distortions during recording by e.g. a handheld camera are not detrimental to the embedded watermark and the subsequent detecting thereof. The watermark is embedded by modulating a global property of the frames, e.g. the mean luminance, and the detection is performed by correlating the watermark sequence with extracted mean luminance values of a sequence of frames. WO 03/001813 assigned to the same assignee as the present invention is hereby incorporated by reference.

In the coming years, the digital cinema format, 1920×1080×24×36 (pixels/line x lines/frame x frames/second x bits/pixel), will be introduced in the theaters. This will introduce improved viewer experiences of displayed movies but this also introduces complications. Firstly, the enhanced spatial resolution makes unauthorized copying even more attractive due the similarly enhanced quality of such illegal copies. Secondly, this implies that the complexity of watermark embedding also increase as this complexity is directly related to the frame rate and the spatial resolution of the frames because the embedding processing means has to work correspondingly faster.

Hence, an improved watermark embedding method would be advantageous, and in particular a more efficient and/or simple watermark embedding method would be advantageous.

### SUMMARY OF THE INVENTION

Accordingly, the invention preferably seeks to mitigate, alleviate or eliminate one or more of the above-mentioned disadvantages singly or in any combination. In particular, it may be seen as an object of the present invention to provide a simple watermark embedding method that solves the above-mentioned problems of the prior art with the increased frame rate and/or the increased spatial resolution.

This object and several other objects are obtained in a first aspect of the invention by providing a method for embedding a watermark (w) in a motion image signal, the method comprising the steps of:

representing said watermark by a sequence of watermark samples,

providing sharpness changing means capable of changing the sharpness of a motion image signal, and

changing the sharpness in response to said watermark samples so as to embed the watermark in the motion image signal.

The invention is particularly but not exclusively advantageous for obtaining an embedded watermark by slightly modulating the sharpness state of the optical image so as to embed information i.e. the watermark directly in the optical domain. Thus, there is no need for comprehensive processing means for analyzing, modifying, and further transmitting the motion image signal. The watermark should of course be embedded in an imperceptible manner, i.e. a normal viewer or user should not notice the watermark as will be discussed below. The sharpness changes in the motion image signal may comprise both changes in the spatial resolution and the acutance level. Changes in the sharpness of the images constituting the motion image signal may be detected by methods well known in the field such as high-pass filtering or low-pass filtering. In the latter case, the level of high frequency components will be reduced or eliminated when the sharpness is reduced.

Factors that may influence the sharpness in a recording situation comprise relative movement of the object being visually recorded, lens movement, lens resolution, lens aperture, movement of optical recording element, and resolution of optical recording element.

Factors that may influence the sharpness in a reproducing situation comprise movement of a screen or similar, lens movement, lens resolution, lens aperture, movement of optical reproducing element, resolution of optical reproducing element.

In particular, the motion image signal may be transmitted through the sharpness changing means, if e.g. the sharpness changing means is a lens.

In particular, the watermark may be embedded in the motion image signal during recording of the motion image signal. In this way, the watermark will from the very beginning be inherently embedded in the electrical representation or the film spool. Specifically, the watermark may be embedded in the motion image signal by displacing at least one entity from the group of: an object being recorded, an optical recording element, e.g. the film camera, and an optical element associated with said optical recording element, e.g. a lens, a mirror or similar element.

In particular, the watermark may be embedded in the motion image signal during reproducing of the motion image signal, e.g. during projector output in a cinema etc. This may be done by displacing at least one entity from the group of: screening means, e.g. a screen, for displaying the motion image signal, an optical reproducing element, e.g. a projector, and an optical element associated with said optical reproducing element, e.g. a lens, a mirror or similar element

As mentioned above, a perceptual model may beneficially control the changing of the sharpness changing means to ensure imperceptibility to the ordinary viewer.

In particular, the changing of the sharpness changing means may be adapted for embedding a multi-level information value, preferably a binary level value or a triplicate level value.

In a particular embodiment, the sharpness changing means may comprise focusing means adapted for changing the focal distance and/or the position of the focal point of said focusing means. The focusing means may comprise an optical component chosen from the non-exhaustive group of: a solid lens, and a liquid lens.

In a second aspect, the present invention relates to an apparatus for embedding a watermark in a motion image signal, the apparatus comprises:

storage means capable of storing said watermark by a sequence of watermark samples,

sharpness changing means capable of changing the sharpness of a motion image signal, and

wherein the sharpness changing means is adapted for changing the sharpness in response to said watermark samples so as to embed the watermark in the motion image signal.

Beneficially, a motion image signal recording device may comprise an apparatus according to the second aspect.

In a third aspect, the present invention relates to a motion image signal with an embedded watermark represented by a sequence of watermark samples, wherein the watermark samples has been embedded by modifying the focus state in the motion image signal in response to said watermark samples. In particular, a storage medium having recorded thereon a motion image signal may comprise a signal according to the third aspect. The storage medium may be any kind of optical medium or magnetic medium. Also the storage medium may include positive or negative movie spools.

The first, second, and third aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained with reference to the accompanying Figures, where

FIG. 1 schematically illustrates an object that is correctly focused,

FIG. 2 schematically illustrates an object that is not focused,

FIG. 3 shows a schematic drawing for embedding a watermark according to the present invention during a recording situation,

FIG. 4 shows a schematic drawing for embedding a watermark according to the present invention during a reproducing situation, e.g. in a cinema,

FIG. 5 shows different focus states during embedding, and

FIG. 6 shows different focus states embedded with a phase shift modulation scheme.

### DETAILED DESCRIPTION OF THE INVENTION

The invention according to the first aspect is a method for embedding a watermark (w) in a motion image signal in essentially three steps. Initially, the watermark, i.e. the information for embedding has to be represented by a sequence of watermark samples. Secondly, sharpness changing means capable of changing the sharpness of the motion image signal are provided, and lastly, during operation the sharpness changing means are capable of changing sharpness in response to the watermark samples, and thereby embedding the watermark in the motion image signal in a simple and efficient manner in the optical domain. Changing of the sharpness is accordingly an essential feature of the invention, and therefore definitions of sharpness and some related optical concepts are given immediately below.

In optics, an object may be defined as anything that from which light rays emanate. The object can be luminous, i.e. the object is a source of light, or the object can reflective of light from another source of light. Similarly, an image is considered to be a reproduction of an object formed from light. Images can be real images formed on a surface, e.g. a screen, or images can be virtual images that only exist because they are perceived to exist, e.g. a hologram or such.

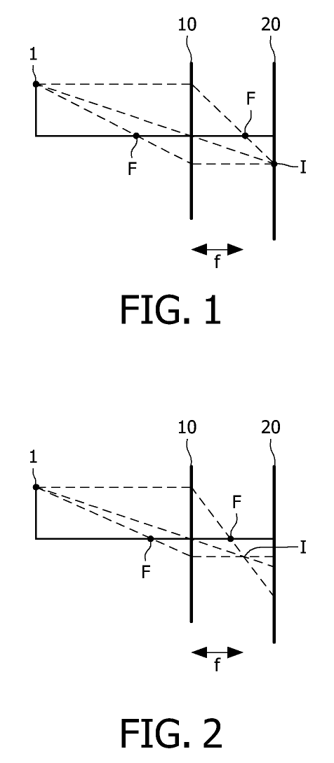

FIG. 1 schematically illustrates an object 1 that is correctly focused when the object 1 is imaged through a lens 10 onto an optical sensor 20, e.g. a charge-coupled device (CCD) or other recording devices. By correctly focused it is to be understood that the distances between object 1, lens 10 and sensor 20 are adjusted so that rays emerging object point 1 intersect in a single point, i.e. the imaging point I, on the optical sensor 20 so as to enable a perfect or nearly perfect imaging of the object 1 on the sensor 20, i.e. the image has a high degree of sharpness. The object 1 can be said to be “in focus”. The focal distance f of the lens 10 can be defined as the distance from a plane substantially comprising the lens 10 to the plane where a collimated beam incident onto the lens 10 will focus.

FIG. 2 on the contrary schematically illustrates an object 1 that is not correctly focused, i.e. the object 1 is said to be “out of focus”. In this example, the rays emerging from object point 1 intersects in a point I positioned in front of the optical sensor 20, and consequently the optical image of the object 1 is not correct imaged on the sensor 20, the result being a blurred or distorted image of the object 1 on the sensor 20, i.e. the image on the sensor 20 has a low degree of sharpness.

The sharpness changing means according the present invention may be a lens 10 as shown in the FIGS. 1 and 2. In optics, a lens 10 is typically a piece of glass or other transparent substance that is used to form an image of an object 1 by focusing rays of light from the object 1. A lens 10 is often a piece of transparent material as glass or plastic, usually circular in shape, with two polished surfaces, either or both of which is curved and may be either convex (bulging) or concave (depressed). The curves are almost always spherical, i.e., the radius of curvature is constant. In an embodiment of the present invention, the lens 10 is displaced, e.g. tilted, moved along the optical axis, moved perpendicular to the optical axis, or any combination thereof, in response to the water mark samples on the temporal axis. In another embodiment, the optical sensor 20 is displaced, e.g. tilted, moved along the optical axis, moved perpendicular to the optical, or any combination thereof, in response to the water mark samples on the temporal axis. Alternatively, the object 1 is displaced, e.g. tilted, moved along the optical axis, moved perpendicular to the optical axis, or any combination thereof, in response to the water mark samples on the temporal axis. For displacement of the object 1, the lens 10 or the optical sensor 20 dedicated actuation means (not shown), e.g. electrical actuators, piezo-electrical actuators, with a sufficiently short time response should be provided. The time response should be in order of 0.001 milliseconds, 0.01 milliseconds, 0.1 milliseconds, 1 millisecond, or 10 milliseconds.

The above listed definitions of focusing concepts, i.e. focal point F and focal distance f, are strictly speaking only valid for a perfect lens 10, i.e. a thin lens, and a monochromatic transmitted image. Practical optical systems imperfections will give rise to various optical effects, e.g. aberrations such a spherical and chromatic aberration. Thus, optical systems of practical interest often comprise several lenses to compensate for aberration. However, the present invention may also be applied in such multi-lens optical systems.

Recently, a new kind of liquid lens with variable focus has been demonstrated, see e.g. WO 03/069380 to Koninklijke Philips Electronics, and this kind of lenses may be of particular use within the context of the present invention. The liquid lens utilities a first and a second non-miscible liquid of different refractive indices that are in contact over a meniscus and electrically contacted by a contact layer. Applying a pre-determined voltage to the contact layer results in a so-called electro-wetting effect where one of the liquids changes wet ability causing a different meniscus shape, and hence the focal point and focal distance of the liquid lens is changed accordingly. The liquid lens is particular beneficially applied within the context of the present invention because the meniscus change has a quite short response and relaxation time, typically on the order of milliseconds, which make liquid lenses well suited for watermark embedding in the optical domain.

It is also contemplated, that future design of liquid lenses may implement multi-focal lenses, i.e. where distinct portions of the lens may be changed independently of each other. Thus, say an edge portion of the liquid lens is changed while a central portion of the liquid lens is unchanged, this may reduce the perceptibility of an embedded watermark. The present invention may also be applied for solid multi-focal lenses with several lens portions, possibly having variable focusing capabilities. In this respect, each lens portion may be considered to locally embed a watermark.

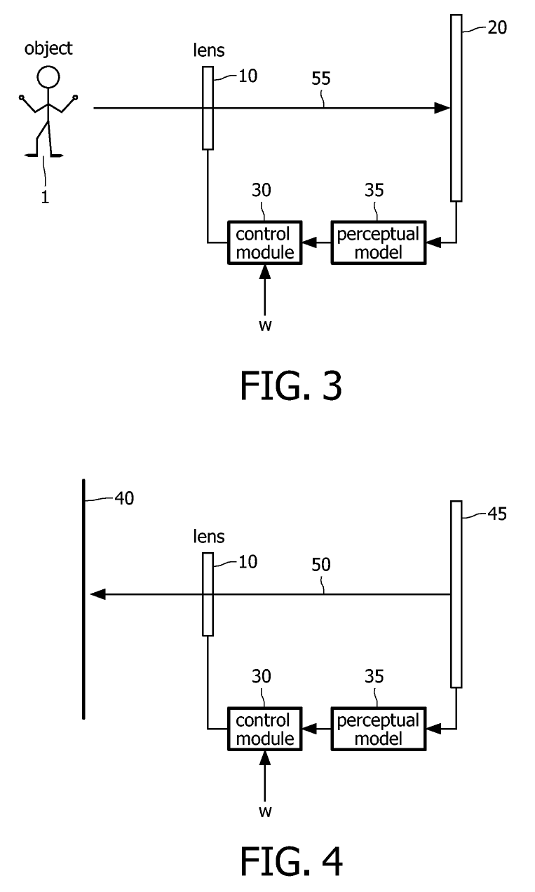

FIG. 3 shows a schematic drawing for embedding a watermark w according to the present invention during a recording by the optical sensor 20. From the object 1 light or a motion image signal 55 emanate through the lens 10 onto sensor 20. The object 1 may be an actor participating in a movie or a person in a private occasion being video recorded. To obtain a satisfactory result the object 1 has to be imaged onto the recording surface of the sensor 20 in a correct manner, i.e. the object 1 has to imaged with a high degree of sharpness as defined above. The focusing lens 10 may be manually controlled by an operator, or alternatively by a closed-loop autofocus control circuit (not shown). In the latter case, a control module 30 receives a main control signal for controlling the lens 10 accordingly. However, super positioned on the main control signal is a watermarking signal comprising the watermark samples constituting the watermark w. Furthermore, the control module 30 received inputs from a perceptual model module 35, that provides information regarding an upper limit for the level of watermarking ensuring the embedded watermark to remain invisible or imperceptible. Preferably, the perceptual model module 35 may receive information from the optical sensor 20 about the content of recorded motion image signal to facilitate invisible embedding of the watermark samples. However, as the recorded signals in time lacks the actual image motion signal, the information received by the perceptual model module 35 from the recording sensor 20 is based on earlier content and dynamics of the image motion signal, and hence some caution should be taken upon application of the received information.

It is a particular advantage of the present invention, that the recorded image motion signal upon recording comprises the embedded watermark w. Thus, an electrical signal representing the image motion signal will inherently contain the watermark w. Conventional methods have relied on embedding a watermark after recording but this constitutes a potential risk because copies of the unmarked recordings could be illegally distributed. This risk is eliminated by application of the present invention in a recording situation. Furthermore, a typically recording device will contain a lens for conventional focusing purposes that may be implemented by the present invention provided e.g. that the time response of the lens is sufficient small.

FIG. 4 shows a schematic drawing for embedding a watermark w according to the present invention during a reproducing situation, e.g. in a cinema, where a projection device 45 emits an image motion signal 50 that is transmitted through the lens 10 onto a screen 40. For a satisfactory viewing experience the image motion signal should be focused on the screen 40. The focusing lens 10 may be manually controlled by a cinema operator, or alternatively by a closed-loop auto-focus control circuit (not shown). In the latter case, a control module 30 receives a main control signal for controlling the lens 10 accordingly. However, super positioned on the main control signal is a watermarking control signal comprising the watermark samples constituting the watermark w. Additionally, the control module 30 received inputs from the a perceptual model module 35, that provides information e.g. regarding an upper limit for the level of watermarking for ensuring the embedded watermark to remain invisible or imperceptible. The perceptual model advantageously receives information about the displayed image motion signal, e.g. motion-scaling may be implemented from an analysis as disclosed in WO 03/001813. Thus, if the motion image signal has a high degree of motion more information may be embedded as the human eye has difficulties focusing on fast-moving object, and vice versa. Alternatively, the input can also come from an external source. For example, in the auxiliary data of the MPEG stream.

The applied perceptual model should advantageously enhance the properties of the embedded watermark with respect to the three key requirements of a watermarking scheme: 1) robustness, 2) imperceptibility, 3) a low false positive rate, and 4) payload, i.e. the amount of information to be embedded. As a first example it is possible to do an analysis of the image motion signal, perform e.g. a high-pass filtering, which indicates how much areas in the frame can be distorted. If the image contains a lot of high frequencies, then the de-focusing should be limited. The smallest allowed amount of distortion is used to control the de-focusing module. Of course this amount of de-focusing can also depend on the required robustness. If the robustness requirement is high, then image needs to be more out-of-focus. Another example of a perceptual model is simply to repeat the same watermark sample for T consecutive frames to lower the in-focus de-focus frequency, which makes it more difficult for the human eye to see the watermark, see e.g. WO 03/001813 where T is five in an example. The repeating of the same watermark sample for T consecutive frames also increase the signal-to-noise ratio and in turn lowers the false positive rate.

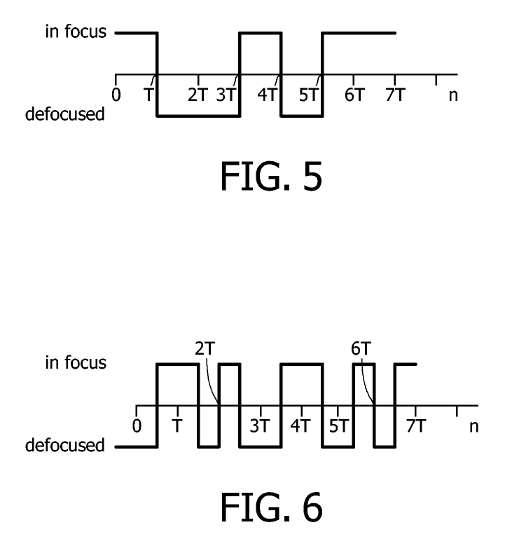

FIG. 5 shows different focus states for embedding the watermark samples 1, −1, −1, 1, −1, 1, 1, where the upper states is the focused state and the lower state is a defocused state.

FIG. 6 shows different focus states embedded with a phase shift modulation scheme, where the up and down going edges are applied. The watermark samples are the same as for FIG. 5.

A watermark embedded according to the present invention may be detected by the method disclosed in WO 03/001813. The global property calculated for detecting the watermark may be the variance of luminance values of a sequence of frames.

A particularly detection situation may arise when applied sharpness changes for watermark embedding during a recording situation according to the first aspect of invention. Under certain conditions it may be required to perform special analysis for correct detection if the watermark has been embedded during the original recording of the image motion signal, e.g. a movie or similar. For instances, if an object 1 becomes out-of-focus, then it might be possible that another objects comes in focus resulting in a possibly false positive embedded value. However, a method is disclosed in Proceedings of the SPIE, Volume 5020, 2003, pp. 526-535 (Arno van Leest et al.) for reducing, possibly eliminating, the risk of such a situation. This object is achieved by dividing of an image into sub-images, so-called tiling.

In summary, the present invention relates to a method for embedding a watermark (w) in an image motion signal (55). The invention describes a method for embedding a watermark (w) in a motion image signal (55) in the optical domain in several steps. Initially, the watermark, i.e. the information for embedding, is represented by a sequence of watermark samples. During embedding sharpness changing means (10) are applied to change the sharpness in response to the watermark samples, and thereby embedding the watermark in the motion image signal (55) in a simple and efficient manner in the optical domain. The sharpness changing can be implemented by various ways, e.g. by displacing a lens (10) slightly. A particular embodiment exploits a variable focus lens having a liquid lens operated by electro-wetting. Further, the present invention relates to a corresponding apparatus for embedding the watermark.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for embedding a watermark (w) in a motion image signal (50, 55), the method comprising the steps of:
representing said watermark by a sequence of watermark samples,
providing sharpness changing means (1, 10, 20) capable of changing the sharpness of a motion image signal, and
changing the sharpness in response to said watermark samples so as to embed the watermark in the motion image signal.

2. A method according to claim 1, wherein the motion image signal (50, 55) is transmitted through said sharpness changing means (10).

3. A method according to claim 1, wherein the watermark (w) is embedded in the motion image signal (55) during recording of said motion image signal.

4. A method according to claim 3, wherein the watermark is embedded in the motion image signal by displacing at least one entity from the group of: an object (1) being recorded, an optical recording element (20), and an optical element (10) associated with said optical recording element.

5. A method according to claim 1, wherein the watermark (w) is embedded in the motion image signal (50) during reproducing of said motion image signal.

6. A method according to claim 5, wherein the watermark is embedded in the motion image signal by displacing at least one entity from the group of: screening means (40) for displaying the motion image signal, an optical reproducing element (45), and an optical element (10) associated with said optical reproducing element.

7. A method according to claim 1, wherein the changing of the sharpness changing means is, at least partly, controlled by a perceptual model (35).

8. A method according to claim 1, wherein the changing of the sharpness changing means is adapted for embedding a multi-level information value, preferably a binary level value or a triplicate level value.

9. A method according to claim 2, wherein the sharpness changing means comprises focusing means (10) adapted for changing the focal distance and/or the position of the focal point of said focusing means.

10. A method according to claim 9, wherein the focusing means comprises an optical component chosen from the group of: a solid lens, and a liquid lens.

11. An apparatus for embedding a watermark (w) in a motion image signal (50, 55), the apparatus comprising:
storage means capable of storing said watermark by a sequence of watermark samples,
harpness changing means (1, 10, 20) capable of changing the sharpness of a motion image signal, and
wherein the sharpness changing means is adapted for changing the sharpness in response to said watermark samples so as to embed the water mark in the motion image signal.

12. A motion image recording device comprising an apparatus according to claim 11.

13. A motion image signal (50, 55) with an embedded watermark (w) represented by a sequence of watermark samples, wherein the watermark samples has been embedded by modifying the focus state in the motion image signal in response to said watermark samples.

14. A storage medium having recorded thereon a motion image signal (50, 55) according to claim 13.
